(19) United States
(12) Patent Application Publication
(10) Pub. No.: US 2016/0300188 A1
(43) Pub. Date: Oct. 13, 2016

(54) DEVICE AND PROGRAM FOR CALCULATING PHYSICAL DISTRIBUTION BASE ARRANGEMENT PLAN

(71) Applicant: HITACHI, LTD., Tokyo (JP)

(72) Inventor: Junko HOSODA, Tokyo (JP)

(73) Assignee: HITACHI, LTD., Tokyo (JP)

(21) Appl. No.: 15/026,846

(22) PCT Filed: Oct. 2, 2013
(86) PCT No.: PCT/JP2013/076760

§ 371 Date: Apr. 1, 2016

(51) Int. Cl. G06Q 10/08; G06Q 50/28

(52) U.S. Cl. CPC G06Q 10/0875; G06Q 10/0833; G06Q 50/28

(57) ABSTRACT

Provided are a physical distribution base arrangement plan calculating device and program with which physical distribution bases are consolidated at timing that does not cause a loss of a sales chance or an excessive cost. The physical distribution base arrangement plan calculating device and program has a function of: periodically processing actual logistics performance information to calculate changes in a monitoring item; calculating, when the changes have an increasing or decreasing trend, a physical distribution base arrangement plan by changing a parameter that is controllable with respect to a predicted future transport quantity; comparing the calculated physical distribution base arrangement plan and the current physical distribution base arrangement in profit; and, when the profit of the calculated plan is greater, displaying a message to the effect that the base arrangement needs to be revised.

### TECHNICAL FIELD

The present invention relates to a physical distribution base arrangement plan calculating device.

### BACKGROUND ART

The background art in the technical field of the present invention includes Japanese Patent Laid-open Publication No. 2003-196359 (Patent Literature 1). This publication states that “provided is a physical distribution center planning method and physical distribution planning system capable of comparing logistics costs in a short time” (see Abstract).

### CITATION LIST

### Patent Literature

[PTL 1] Japanese Patent Laid-open Publication No. 2003-196359

### SUMMARY OF INVENTION

### Technical Problem

In Patent Literature 1, there is disclosed a scheme of evaluating a logistics cost of a physical distribution center consolidation plan. The scheme of Patent Literature 1 requires manual determination of when to develop a plan for consolidating physical distribution centers, which means that a delay in developing a consolidation plan may bring about a loss of a sales chance or an excessive cost.

The present invention therefore provides a physical distribution arrangement plan calculating device configured to calculate a physical distribution base consolidation plan at timing that does not cause a loss of a sales chance or an excessive cost.

### Solution to Problem

In order to solve the above-mentioned problem, according to one embodiment of the present invention, there is provided a physical distribution base arrangement plan calculating device, including: a storing unit configured to store stock arrival processing capability information, stock arrival information, actual performance information about transportation from a sender base to a shipment arrival base, transport cost information about transportation from a sender base to a shipment arrival base, logistics changing cost information, and monitoring item information, the stock arrival processing capability information including a processing capability of each warehouse, the stock arrival information including actual stock arrival performance of each warehouse, the logistics changing cost information including a cost that is incurred by changing a business operation of a current base arrangement, the monitoring item information including items that are used to determine whether or not a base arrangement needs to be revised; and a base arrangement plan calculating unit configured to periodically calculate changes in monitoring items of the monitoring item information based on the stock arrival processing capability information, the stock arrival information, and the actual performance information, which are stored in the storing unit, and, when an increasing trend or a decreasing trend of the calculated changes is detected in one of the monitoring items, change a parameter that influences the one of the monitoring items, and calculate a new base arrangement plan based on the transport cost information and the logistics changing cost information.

### Advantageous Effects of Invention

A logistics framework suitable for a user can be built at the right timing.

### BRIEF DESCRIPTION OF DRAWINGS

FIG. 1 is an example of a block diagram of a physical distribution base arrangement plan calculating device.

FIG. 2 is a hardware configuration example of the physical distribution base arrangement plan calculating device.

FIG. 3 is an example of a flow of physical distribution base arrangement plan calculating processing.

FIG. 4 is an example of stock arrival processing capability information.

FIG. 5 is an example of stock arrival information.

FIG. 6 is an example of transport cost information.

FIG. 7 is an example of monitoring item information.

FIG. 8 is an example of product-by-product actual transport performance information.

FIG. 9 is an example of route-by-route actual transport performance information.

FIG. 10 is an example of logistics changing cost information.

FIG. 11 is an example of revision presentation reference information.

FIG. 12 is an example of a flow of base arrangement revision timing detecting processing.

FIG. 13 is an example of truck loading ratio change information.

FIG. 14 is an example of a revision item list.

FIG. 15 is an example of a flow of base arrangement revision plan calculating processing.

FIG. 16 is an example of financial index prediction information.

FIG. 17 is an example of new base arrangement plan information.

FIG. 18 is an example of a screen for displaying the result of base arrangement revision timing detection.

FIG. 19 is an example of a screen for displaying a base arrangement revision plan.

### DESCRIPTION OF EMBODIMENTS

Now, an embodiment of the present invention is described with reference to the drawings.

### First Embodiment

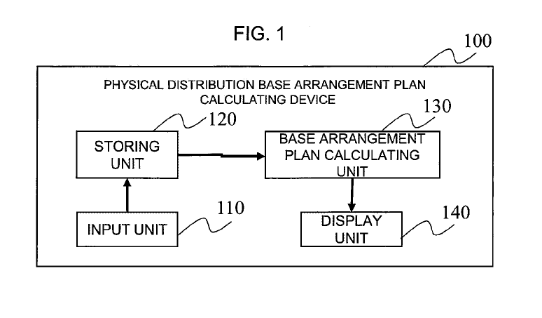

FIG. 1 is a block diagram for illustrating the function configuration of a physical distribution base arrangement plan calculating device according to this embodiment. A physical distribution base arrangement plan calculating device 100 includes an input unit 110, a storing unit 120, a base arrangement plan calculating unit 130, and a display unit 140. The input unit 110 reads external data and stores the external data in the storing unit 120. The storing unit 120 stores external data. The base arrangement plan calculating unit 130 uses external data stored in the storing unit 120 to determine whether or not a physical distribution base arrangement plan needs to be revised. The display unit 140 is a user interface configured to display various operation screens, images, and others by following instructions from other function units.

The term “physical distribution base arrangement plan” in the present invention refers to a wide concept that encompasses not only a plan on which physical distribution base, such as a warehouse, is to be disposed where, but also a plan that sets for each physical distribution base a mode of transportation and a plan that sets for each physical distribution base a processing capability.

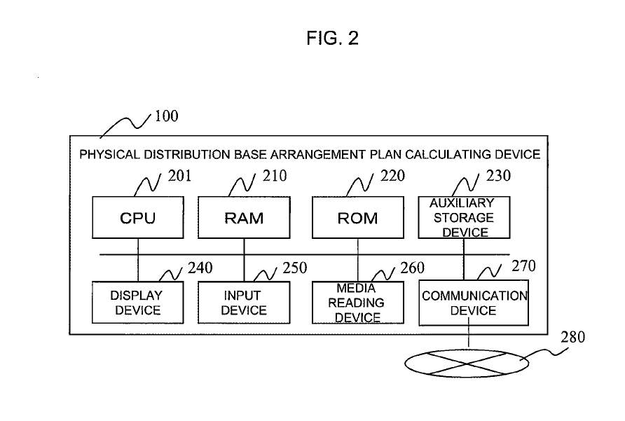

FIG. 2 is a block diagram for illustrating a hardware configuration example of the physical distribution base arrangement plan calculating device 100 according to this embodiment. The physical distribution base arrangement plan calculating device 100 includes a CPU 201, a RAM 210, a ROM 220, an auxiliary storage device 230, a display device 240, an input device 250, a media reading device 260, and a communication device 270. The CPU 201 is a unit configured to execute various types of computing. The CPU 201 executes various types of processing by running a given physical distribution base arrangement plan calculating program (not shown), which is loaded onto the RAM 210 from the auxiliary storage device 230.

The physical distribution base arrangement plan calculating program is, for example, an application program that can be run on an operating system (OS) program.

The physical distribution base arrangement plan calculating program may be installed in the auxiliary storage device 230 from, for example, a portable storage medium via the media reading device 260. The RAM 210 is a memory configured to store, among others, programs executed by the CPU 201, and data necessary to execute the programs. The ROM 220 is a memory configured to store, among others, a program necessary to boot up the physical distribution base arrangement plan calculating device 100.

The auxiliary storage device 230 is a hard disk drive (HDD) or a similar device, or may be a solid state drive (SSD) that uses a flash memory or the like. The display device 240 is a CRT display, a liquid crystal display (LCD), an organic electro-luminescence (EL) display, or a similar device. The input device 250 is a keyboard, a mouse, a microphone, and/or other similar devices. The media reading device 260 is a device configured to read information out of a CD-ROM and other portable storage media that can be carried around. The communication device 270 inputs and outputs data to and from an external device via a network 280.

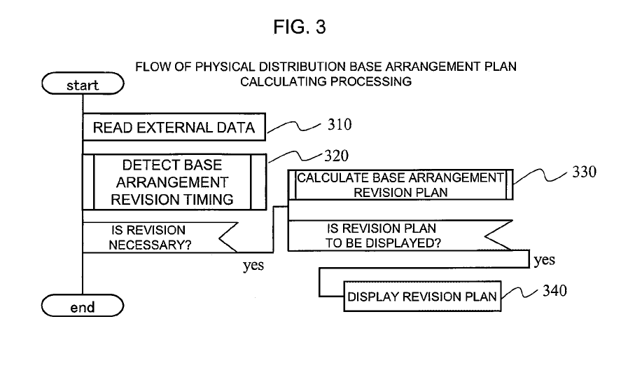

FIG. 3 is an example of a physical distribution base arrangement plan calculating processing flow for illustrating processing that is executed by the physical distribution base arrangement plan calculating device 100. The physical distribution base arrangement plan calculating processing includes executing (1) external data reading processing 310 first, next executing (2) base arrangement revision timing detecting processing 320 to determine whether or not the base arrangement needs to be revised, executing (3) base arrangement revision plan calculating processing 330 when it is determined that the base arrangement needs to be revised, and executing (4) revision plan display processing 340 when it is determined as a result of the processing of 330 that a revision plan needs to be presented to the user. When there is no need to present a revision plan, a message to the effect that revision is unnecessary is displayed, or display about revision is not executed altogether.

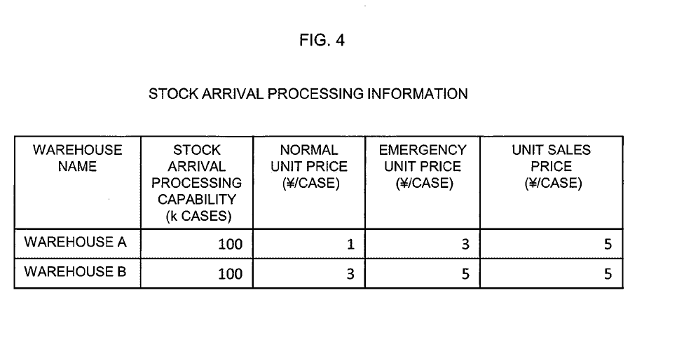

The processing procedures (1) to (4) of FIG. 3 are described below with reference to FIG. 4 to FIG. 19.

(1) External Data Reading Processing 310

The external data reading processing 310 of FIG. 3 involves reading stock arrival processing capability information, stock arrival information, product-by-product actual transport performance information, route-by-route actual transport performance information, transport cost information, logistics changing cost information, monitoring item information, and revision presentation reference information, which are external data.

The external data reading processing 310 involves storing, in the storing unit 120, data taken in by the input unit 110 of FIG. 1. Specifically, the external data is taken in through the media reading device 260 or the communication device 270 to be stored in the auxiliary storage device 230.

FIG. 4 is an example of the stock arrival processing capability information. The stock arrival processing capability information includes at least data items that define the name of a warehouse and the stock arrival processing capability of the warehouse.

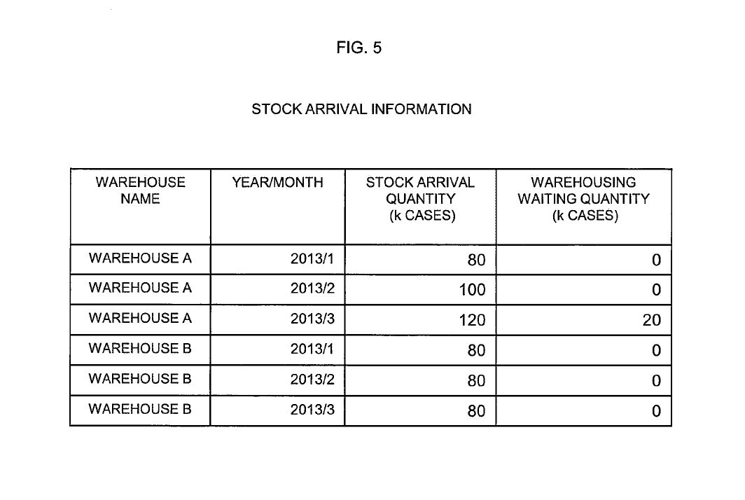

FIG. 5 is an example of the stock arrival information. The stock arrival information includes at least data items that define the name of a warehouse, a year/month, a stock arrival quantity processed by the warehouse in the year/month, and a warehousing waiting quantity, which indicates how much of the stock arrival quantity has required a given length of time or longer to be processed by the stock arrival processing since the arrival of the product.

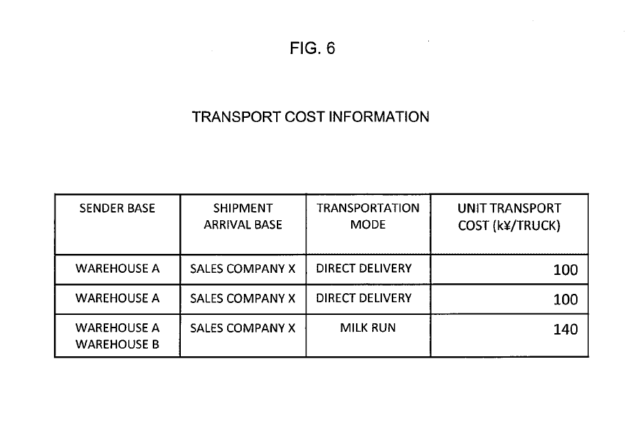

FIG. 6 is an example of the transport cost information. The transport cost information includes at least data items that define the name of a sender base, the name of a shipment arrival base, the mode of transportation from the sender base to the shipment arrival base, and a transport cost required for this transportation.

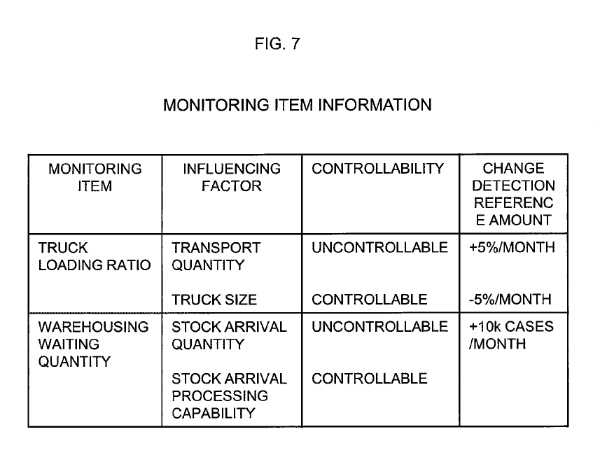

FIG. 7 is an example of the monitoring item information. The monitoring item information includes data items that define a monitoring item for which a value is calculated periodically, an influencing factor that influences an increase and decrease of the monitoring item, the controllability/uncontrollability of the influencing factor, and a change detection reference amount, which serves as a reference value when time-series changes of the monitoring item are detected. While the monthly amount of change of the monitoring item is used as the change detection reference amount in FIG. 7, an objective value of the monitoring item may be input in order to use a difference from the objective value as the change detection reference amount. The change amount may also be calculated from a comparison to a value in the same month of the last year, by taking into consideration fluctuations due to a seasonal factor. In other examples than that of FIG. 7, the in-stock quantity of the warehouse and the quantity of stock retrieved from the warehouse may be provided as monitoring items.

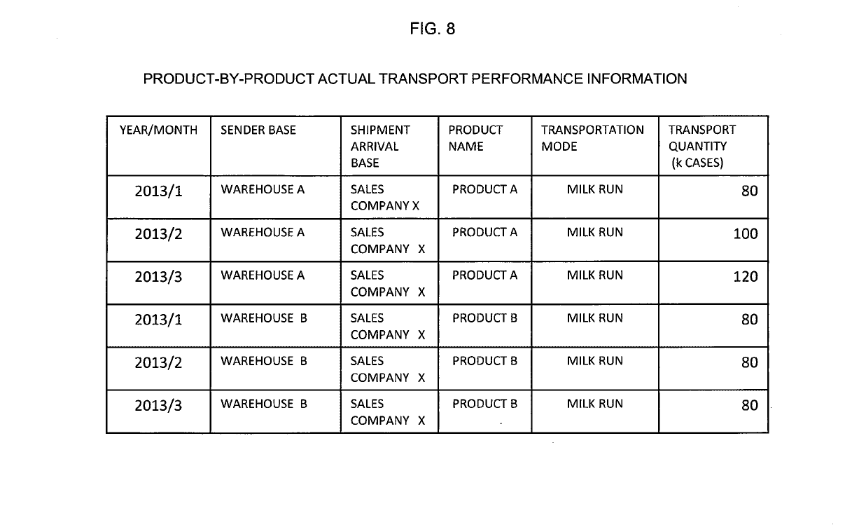

FIG. 8 is an example of the product-by-product actual transport performance information. The product-by-product actual transport performance information includes at least data items that define a year/month in which transportation has taken place, the name of a sender base, the name of a shipment arrival base, the name of a product transported, the mode of transportation from the sender base to the shipment arrival base, and a transport quantity.

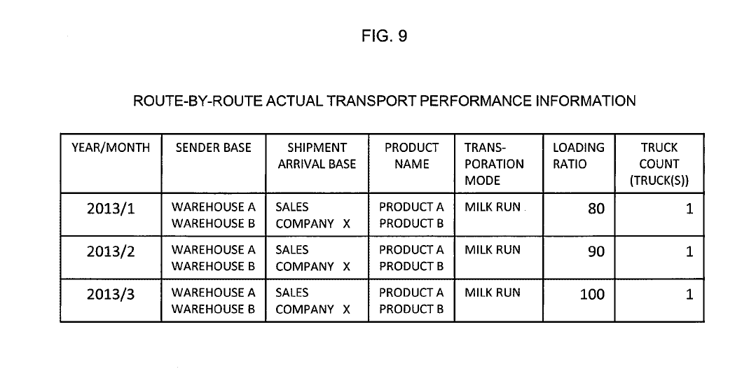

FIG. 9 is an example of the route-by-route actual transport performance information. The route-by-route actual transport performance information includes at least data items that define a year/month in which transportation has taken place, the name of a sender base, the name of a shipment arrival base, the name of a product transported, the mode of transportation from the sender base to the shipment arrival base, a truck loading ratio, which is calculated by dividing a transport quantity in this mode of transportation by a transportable quantity (a value calculated by multiplying the number of trucks by a numerical quantity that can be transported by a single truck), and the number of trucks used in this mode of transportation.

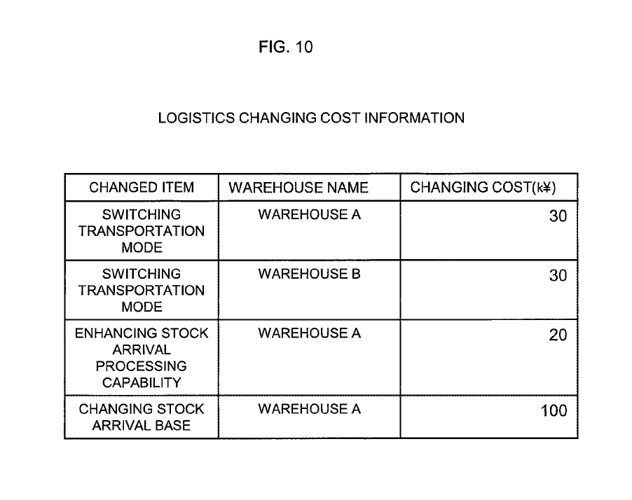

FIG. 10 is an example of the logistics changing cost information. The logistics changing cost information includes at least data items that define a changed item, which indicates the specifics of a change to be made, the name of a warehouse to which the change is made, and a changing cost required to make the change.

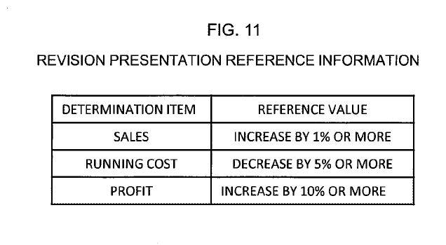

FIG. 11 is an example of the revision presentation reference information. The revision presentation reference information includes at least data items that define a determination item used to determine whether or not a revision plan is to be presented, and a reference value for the determination.

When the taking in of the external data described above with reference to FIG. 4 to FIG. 11 is finished, (2) the base arrangement revision timing detecting processing 320 is started.

(2) Base Arrangement Revision Timing Detecting Processing 320

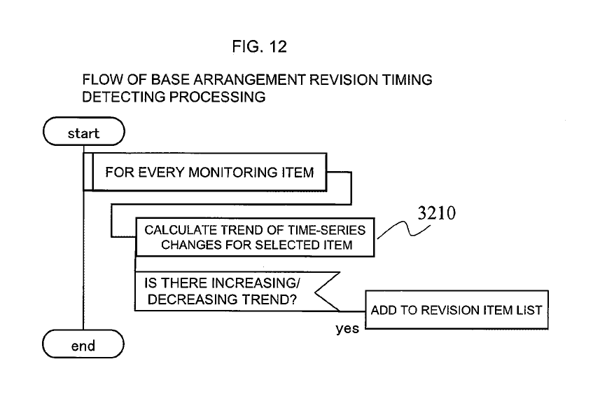

In the base arrangement revision timing detecting processing 320 of FIG. 3, the trend of time-series changes is calculated for every monitoring item from actual performance values and, when a monitoring item exhibits an increasing or decreasing trend, the monitoring item is added to a revision item list as illustrated in a flow of FIG. 12. This processing is executed periodically, for example, once a month.

The base arrangement revision timing detecting processing 320 is executed by the base arrangement plan calculating unit 130 with the use of data in the storing unit 120 of FIG. 1. Specifically, the CPU 201 loads a program stored in the ROM 220 of FIG. 2, reads data out of the auxiliary storage device 230 onto the RAM 210, executes the processing, and stores the result of the processing in the auxiliary storage device 230.

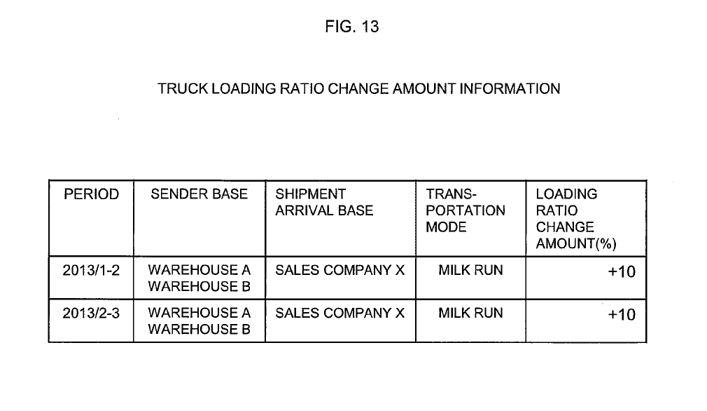

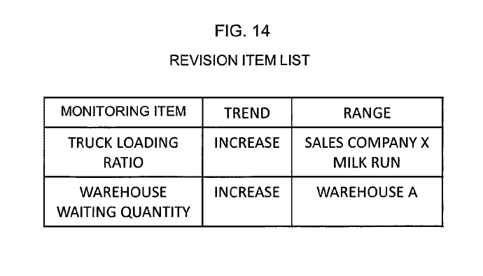

The base arrangement revision timing detecting processing 320 is described below with reference to FIG. 13 and FIG. 14.

The first step of the base arrangement revision timing detecting processing 320 is to calculate the trend of time-series changes for a monitoring item. This involves reading one record of the monitoring item information stored in the storing unit, obtaining the amount of change that the monitoring item of the read record has undergone in a pre-defined evaluation period, which goes back from a pre-defined reference year/month, and saving the obtained amount of change as change amount information of the monitoring item (3210). Specifically, in the case where the reference year/month is 2013/3 and the evaluation period is three months, the truck loading ratio is first read as a monitoring item, three months of records of the route-by-route actual transport performance information since 2013/01 that have the same sender base, shipment arrival base, and mode of transportation are obtained, and changes of the respective months, i.e., changes in 2013/01 to 2013/02 and changes in 2013/02 to 2013/03 are calculated. The result of the calculation is saved in truck loading ratio change information.

FIG. 13 is an example of the truck loading ratio change information. The truck loading ratio change information includes at least data items that define a period for which the amount of change in truck loading ratio is calculated, the name of a sender base, the name of a shipment arrival base, and the amount of change in the average loading ratio of a truck used for the transportation from the sender base to the shipment arrival base.

In the case where the time-series change amount of a monitoring item exceeds the relevant change detection reference amount in the monitoring item information, the monitoring item is added to the revision item list. Specifically, in the case where the truck change detection reference amount is +5%/month or −5%/month, the amount of change in truck loading ratio is +10%/month and the data item “truck loading ratio” is therefore added to the revision item list. Similarly, the warehousing waiting quantity at a warehouse A has changed by +20 k (k represents a thousand) cases and the change amount exceeds the change detection reference amount, and “warehousing waiting quantity” is therefore added to the revision item list.

FIG. 14 is an example of the revision item list. The revision item includes at least data items that define a monitoring item that needs to be revised, the time-series trend of the monitoring item, and a range (bases and the mode of transportation) in which the trend has been observed.

In the case where a record is added to the revision item list in the base arrangement revision timing detecting processing 320, the base arrangement revision plan calculating processing 330 is executed. The base arrangement revision timing detecting processing 320 is ended when no record is added to the revision item list.

(3) Base Arrangement Revision Plan Calculating Processing 330

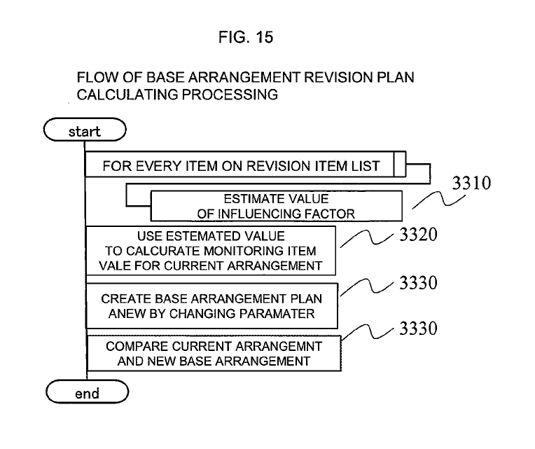

In the base arrangement revision plan calculating processing 330 of FIG. 3, a plan of a revised base arrangement is generated and whether or not the generated revision plan satisfies a revision plan display condition is determined as illustrated in a flow of FIG. 15. The base arrangement revision plan calculating processing 330 is executed by the base arrangement plan calculating unit 130 with the use of data in the storing unit 120 of FIG. 1. Specifically, the CPU 201 loads a program stored in the ROM 220 of FIG. 2, reads data out of the auxiliary storage device 230 onto the RAM 210, executes the processing, and stores the result of the processing in the auxiliary storage device 230.

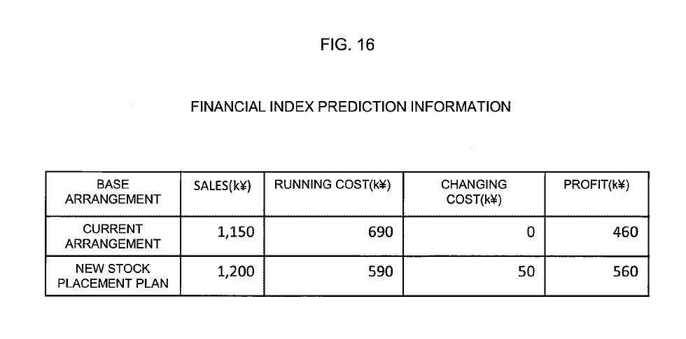

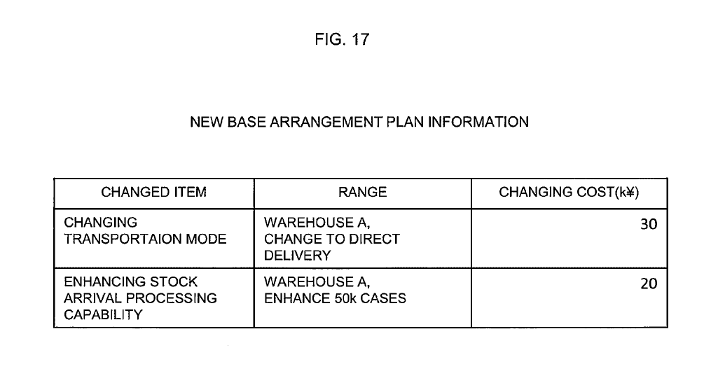

The base arrangement revision plan calculating processing 330 is described below with reference to FIG. 16 and FIG. 17. In the base arrangement revision plan calculating processing 330, one record is readout of the revision item list calculated in the base arrangement revision timing detecting processing 320, and the monitoring item information is referred to in order to identify an influencing factor that cannot be controlled for a monitoring item of the read record of the revision item list. For the identified influencing factor, a value at a point in time that is past the reference year/month by a pre-defined evaluation target period is calculated from the time-series trend of actual performance information (3310). Specifically, for the truck loading ratio, which is the monitoring item in the first record of the revision item list, an influencing factor that cannot be controlled is the transport quantity defined in the monitoring item information, and records of the product-by-product actual transport performance information that hold values “milk run” and “sales company X”, which are in the data item “range” of the revision item list, are identified. The identified records are sorted so that records having the same sender base, shipment arrival base, and product name are grouped together, and the time-series change amount is obtained for each group. The transport quantity of a product A shipped from the warehouse A has increased by 20 k cases/month in 2013/1 to 2013/3, and it is assumed that the transport quantity will increase at a similar pace in the future. In the case where the evaluation target period is two months, the transport quantity of the product A shipped from the warehouse A two month later, i.e., in 2013/05, is calculated as 160 k cases. Similarly, the warehousing waiting quantity in the second record of the revision item list has increased by 20 k cases/month at the warehouse A in 2013/1 to 2013/3, and the stock arrival quantity in 2013/5 is calculated as 160 k cases. While the value of an influencing factor is estimated by linear interpolation in this example, other methods such as multidimensional estimation may be employed.

The values of the influencing factors after the evaluation target period that have been calculated in the processing step 3310 are input to the current base arrangement, and values recorded in the reference year/month for the stock arrival quantity and the transport quantity that are not influencing factors are input to simulate the stock arrival processing quantity and the number of trucks, thereby calculating the values of the monitoring items. Whether the input stock arrival quantity exceeds a maximum stock arrival processing quantity, which is determined in advance, is checked for each warehouse and, when the input quantity exceeds the predetermined maximum quantity, the stock arrival quantity is changed to the maximum stock arrival processing quantity, and the excess stock arrival quantity that exceeds the stock arrival processing capability of the warehouse is set as the warehousing waiting quantity. A value calculated by dividing the input transport quantity by the predetermined numerical loading quantity per truck is set as the number of transport trucks to calculate the truck loading ratio.

The cost, the sales, and the profit are calculated as well. The transport cost is calculated by multiplying the number of transport trucks by a unit transport cost that is written in the transport cost information. The stock arrival processing cost is calculated by multiplying the warehousing waiting quantity by an emergency unit cost that is written in the stock arrival processing capability information, and multiplying the rest of the stock arrival quantity by a normal unit cost. The transport cost and the stock arrival processing cost are added to calculate the cost. The sales are calculated by multiplying the stock arrival quantity by a unit sales price that is written in the stock arrival processing capability information. The profit is calculated by subtracting the cost from the sales. The calculated cost, sales, and profit are saved as financial index prediction information (3320).

Specifically, the stock arrival quantity at the warehouse A is estimated as 160 k cases through the processing step 3310. When the maximum stock arrival processing quantity is set as 1.5 times the stock arrival processing capability, 150 k cases can be warehoused whereas 10 k cases cannot be warehoused. The calculation is therefore made by setting the stock arrival count to 150 k cases and the warehousing waiting count to 50 k cases. The transport quantity of the product A from the warehouse A to the sales company X is 160 k cases, and the transport quantity of a product B from a warehouse B to the sales company X is 80 k cases, which makes the transport quantity of transportation to the sales company X 240 k cases in total. With the numeral loading quantity per truck set to 200 k cases, the number of trucks used is two and the average loading ratio is 60%. In this case, the stock arrival processing cost at the warehouse A is calculated by emergency unit price (3)×emergency arrival quantity (50 k cases)+normal unit price (1)×normal stock arrival quantity (100 k cases) as ¥250 k, the stock arrival processing cost at the warehouse B is calculated by normal unit price (3)×normal stock arrival quantity (80 k cases) as ø240 k, and the stock arrival processing cost is calculated by 250 k+240 k as ¥490 k. The transport cost is calculated by unit transport cost (100 k)×2 as ¥200 k. The running cost is calculated by stock arrival processing cost (¥490 k)+transport cost (¥200 k) as ¥690 k. The sales are calculated by unit sales price (5)×stock arrival quantity (230 k cases) as ¥1,150 k. The profit is calculated by sales (¥1,150 k)−¥690 k as ¥460 k.

After the financial indices are calculated for the current base arrangement in the processing step 3320, the base arrangement is changed by changing a parameter, thus generating a new base arrangement plan (3330). In this example, the parameter to be changed when the truck loading ratio is a monitoring item on the revision item list is the transportation mode in the data item “range”, and the transportation mode is changed to milk run or direct delivery. When the warehousing waiting quantity is a monitoring item on the revision item list, the stock arrival processing capability of a warehouse in the data item “range” is changed, or a switch to another warehouse is made to stock the product in the other warehouse. For the base arrangement plan that has the changed parameter, the truck loading ratio, the warehousing waiting quantity, and the financial indices are calculated the same way as in the processing step 3320. A changing cost that is incurred by changing the parameter is also calculated by obtaining changing costs from the logistics changing cost information. The profit is redefined as sales—running cost—changing cost, and a base arrangement plan that maximizes the profit of the financial indices is saved as new base arrangement plan information. Other than the base arrangement plan that maximizes the profit, a base arrangement plan that maximizes the sales and a base arrangement plan that minimizes the running cost or the changing cost may be saved. Other parameters may also be set. For example, when the truck loading ratio is a monitoring item on the revision item list, the truck size may be changed as a parameter, or the transportation mode may be changed from trucks to trains as a parameter. When the warehousing waiting quantity is a monitoring item on the revision item list, the warehouse size (the use area) or the like may be changed as a parameter.

Specifically, the transportation mode of the sales company X is changed from milk run to direct delivery for the monitoring item in the first record of the revision item list. For the monitoring item in the second record of the revision item list, the stock arrival processing capability of the warehouse A is increased in increments of, for example, 10 k cases (up to 50 k cases), or the stock arrival quantity of the warehouse A is shifted to the warehouse B in units of, for example, 10 k cases. As a result, the profit is maximized in a basement arrangement plan in which the milk run from the warehouse A to the sales company X is changed to direct delivery and the stock arrival processing capability of the warehouse A is enhanced by 50 k cases. The sales in this case are ¥1,200 k, the running cost is ¥590 k, the changing cost is ¥50 k, and the profit is ¥560 k.

The current arrangement and the new stock placement plan in the financial index predication information are compared with respect to a determination item defined in the revision presentation reference information. In the case where the difference brought by the new stock placement plan is equal to or higher than the reference value in the revision presentation reference information, a revision plan is presented (3340). The presented plan may include only the base arrangement plan that maximizes the profit, or may additionally include a base arrangement plan that maximizes the sales and a base arrangement plan that minimizes the running cost or the changing cost. In the case where the difference brought by the new stock placement plan falls short of the reference value, the processing is ended. Other than the comparison between the current arrangement and the new stock placement plan, a pre-defined objective value may be compared to the current arrangement and to a predicted value in the new stock placement plan to determine whether the difference reaches the reference value.

FIG. 16 is an example of the financial index prediction information. The financial index prediction information includes at least data items that define the name of a base arrangement for which indices are calculated, sales obtained in the base arrangement, the running cost in the base arrangement, a changing cost required to change from the current arrangement to the new stock placement plan, and a profit.

FIG. 17 is an example of the new base arrangement plan information. The new base arrangement plan information includes at least data items that define a changed item, which is changed between the current base arrangement and the new base arrangement plan, the range of the change, and a changing cost that is incurred by the change.

(4) Revision Plan Display Processing 340

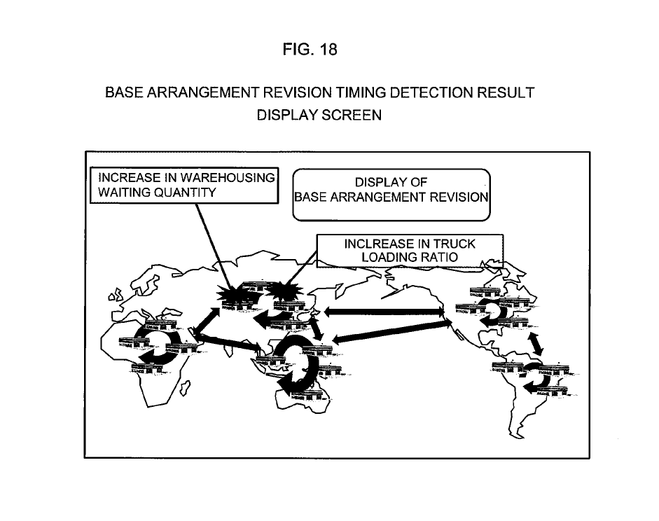

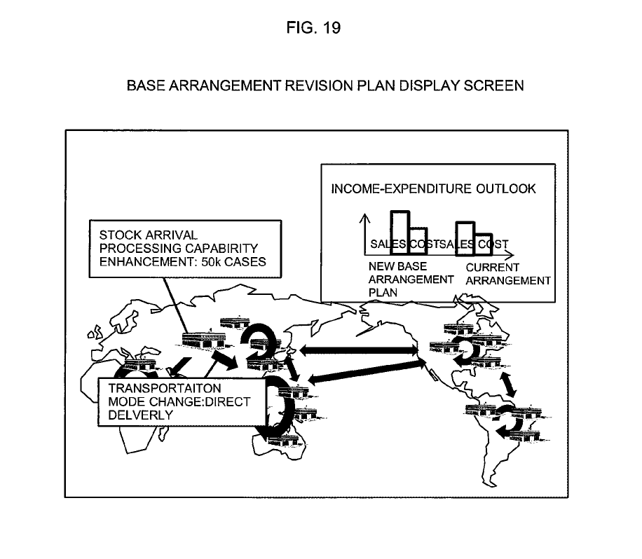

In the revision plan display processing 340 of FIG. 3, result displaying screens of FIG. 18 and FIG. 19 are displayed. The results are displayed by the display unit 150 of FIG. 1. Specifically, the CPU 201 loads a program stored in the ROM 220 of FIG. 2, and also reads data of the auxiliary storage device 230 onto the RAM 210 to output the data to the display device 240. After the result display is finished, the information stored in the auxiliary storage device 230 is saved.

FIG. 18 is an example of a screen for displaying the result of base arrangement revision timing detection. With the revision item list as an input, the base arrangement revision timing detection result display screen displays a revision item and a trend. In FIG. 18, there are two trends, an increase in warehousing waiting quantity and an increase in truck loading ratio. The trends of time-series changes in stock arrival quantity and transport quantity are thus grasped on a region-by-region basis, and a region to which a change is to be made when a future base arrangement plan is considered can be identified.

FIG. 19 is an example of a screen for displaying a base arrangement revision plan. With the new base arrangement plan information and the financial index prediction information as inputs, the base arrangement revision plan display screen displays the specifics of a change that needs to be made when the current arrangement plan is switched to the new arrangement plan, and differences in sales and cost between the current arrangement plan and the new base arrangement plan. Objective values for sales and cost may additionally be displayed. The screen of FIG. 19 indicates that, in order to implement the new base arrangement plan, enhancing the stock arrival processing capability of the warehouse A by 50 k cases and changing the transportation mode to direct delivery are needed. The screen of FIG. 19 also displays an increase in sales and a reduction in cost that are expected when the switch is made, thereby enabling the user to decide whether or not to revise the base arrangement while checking quantitative effects on the degree of difficulty of changing a business operation that is not included in this calculation.

A base arrangement plan in which a warehouse to be used is switched is not discussed in the embodiment described above. However, a base arrangement plan that includes switching a warehouse to be used can be calculated by taking into consideration the cost of adding or eliminating warehouses. For example, when there is a possibility that a warehouse C may newly be added, the addition can be dealt with by thinking up and inputting the stock arrival processing capability information, the transport cost information, and the like about the warehouse C in advance.

Note that, the present invention is not limited to the embodiment described above and covers various modification examples. For instance, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In each embodiment, a part of the configuration of the embodiment may have another configuration added thereto or removed therefrom, or may be replaced by another configuration.

Some of or all of the configurations, functions, processing units, processing means, and the like described above may be implemented by hardware by, for example, designing those as an integrated circuit. The configurations, functions, and the like described above may be implemented by software through a processor's interpretation and execution of programs for implementing the respective functions. The programs for implementing the functions and information such as tables and files can be put in a memory, in a recording device such as a hard disk or a solid state drive (SSD), or in a storage medium such as an IC card, an SD card, or a DVD.

Control lines or information lines considered necessary for description are illustrated, but not all control lines and information lines necessary for a product are illustrated. It may be considered that almost all configurations are actually mutually connected to each other.

1. A physical distribution base arrangement plan calculating device configured to revise a physical distribution base arrangement plan, comprising:
a storing unit configured to store stock arrival processing capability information, stock arrival information, actual performance information about transportation from a sender base to a shipment arrival base, transport cost information about transportation from a sender base to a shipment arrival base, logistics changing cost information, and monitoring item information, the stock arrival processing capability information comprising a processing capability of each warehouse, the stock arrival information comprising actual stock arrival performance of each warehouse, the logistics changing cost information comprising a cost that is incurred by changing a business operation of a current base arrangement, the monitoring item information comprising items that are used to determine whether or not a base arrangement needs to be revised; and
a base arrangement plan calculating unit configured to periodically calculate changes in monitoring items of the monitoring item information based on the stock arrival processing capability information, the stock arrival information, and the actual performance information, which are stored in the storing unit, and, when an increasing trend or a decreasing trend of the calculated changes is detected in one of the monitoring items, change a parameter that influences the one of the monitoring items, and calculate a new base arrangement plan based on the transport cost information and the logistics changing cost information.

2. A physical distribution base arrangement plan calculating device according to claim 1, wherein the base arrangement plan calculating unit is configured to calculate the changes in the monitoring items of the monitoring item information by calculating time-series changes of the monitoring items, or by calculating for each of the monitoring items a difference between a value of the each of the monitoring items and an objective value of the each of the monitoring items.

3. A physical distribution base arrangement plan calculating device according to claim 1, wherein the increasing trend or the decreasing trend of the changes in one of the monitoring items is detected when the changes exceed a given reference.

4. A physical distribution base arrangement plan calculating device according to claim 1, wherein, when a result of a comparison between the calculated new base arrangement plan and the current base arrangement plan reaches a given reference, the base arrangement plan calculating unit is configured to determine that the new base arrangement plan needs to be presented to a user, and output the new base arrangement plan for display.

5. A physical distribution base arrangement plan calculating device according to claim 4, wherein the given reference comprises a reference of a financial index comprising sales, a cost, or a profit.

6. A physical distribution base arrangement plan calculating device according to claim 4, wherein the base arrangement plan calculating unit is configured to determine whether or not the new base arrangement plan needs to be presented to the user by comparing a predicted value of the new base arrangement plan to a pre-defined objective value, in addition to comparing the new base arrangement plan to the current base arrangement plan.

7. A physical distribution base arrangement plan calculating device according to claim 1, wherein the parameter that influences the one of the monitoring items comprises a sender base and a transportation mode in the transport cost information, or a processing capability in the stock arrival processing capability information.

8. A physical distribution base arrangement plan calculating program for revising a physical distribution base arrangement plan by causing a computer to execute:
with use of stock arrival processing capability information, stock arrival information, actual performance information about transportation from a sender base to a shipment arrival base, transport cost information about transportation from a sender base to a shipment arrival base, logistics changing cost information, and monitoring item information, which are stored on the computer, the stock arrival processing capability information comprising a processing capability of each warehouse, the stock arrival information comprising actual stock arrival performance of each warehouse, the logistics changing cost information comprising a cost that is incurred by changing a business operation of a current base arrangement, the monitoring item information comprising items that are used to determine whether or not a base arrangement needs to be revised,
processing of periodically calculating changes in monitoring items of the monitoring item information based on the stock arrival processing capability information, the stock arrival information, and the actual performance information; and
when an increasing trend or a decreasing trend of the calculated changes is detected in one of the monitoring items, processing of changing a parameter that influences the one of the monitoring items, and calculating a new base arrangement plan based on the transport cost information and the logistics changing cost information.

9. A physical distribution base arrangement plan calculating program according to claim 8, wherein the physical distribution base arrangement plan calculating program causes the computer to execute processing of calculating the changes in the monitoring items of the monitoring item information by calculating time-series changes of the monitoring items, or by calculating for each of the monitoring items a difference between a value of the each of the monitoring items and an objective value of the each of the monitoring items.

10. A physical distribution base arrangement plan calculating program according to claim 8, wherein the increasing trend or the decreasing trend of the changes in one of the monitoring items is detected when the changes exceed a given reference.

11. A physical distribution base arrangement plan calculating program according to claim 8, wherein the physical distribution base arrangement plan calculating program causes the computer to execute processing of, when a result of a comparison between the calculated new base arrangement plan and the current base arrangement plan reaches a given reference, determining that the new base arrangement plan needs to be presented to a user, and outputting the new base arrangement plan for display.

12. A physical distribution base arrangement plan calculating program according to claim 11, wherein the given reference comprises a reference of a financial index comprising sales, a cost, or a profit.

13. A physical distribution base arrangement plan calculating program according to claim 11, wherein the physical distribution base arrangement plan calculating program causes the computer to execute processing of determining whether or not the new base arrangement plan needs to be presented to the user by comparing a predicted value of the new base arrangement plan to a pre-defined objective value, in addition to comparing the new base arrangement plan to the current base arrangement plan.

14. A physical distribution base arrangement plan calculating program according to claim 8, wherein the parameter that influences the one of the monitoring items comprises a sender base and a transportation mode in the transport cost information, or a processing capability in the stock arrival processing capability information.
